(19) United States
(12) Patent Application Publication
(10) Pub. No.: US 2026/0109148 A1
(43) Pub. Date: Apr. 23, 2026

(54) CLEANING METHOD AND INK EJECTION APPARATUS

(71) Applicant: CANON KABUSHIKI KAISHA, Tokyo (JP)

(72) Inventors: YUJI NUKUI, Kanagawa (JP); KEIJI TOMIZAWA, Kanagawa (JP); SHUZO IWANAGA, Kanagawa (JP); YUGO YAMAMOTO, Kanagawa (JP); FUMI TANAKA, Kanagawa (JP); YUZURU ISHIDA, Kanagawa (JP); KOJI TAKASE, Kanagawa (JP); KOICHI ISHIDA, Tokyo (JP)

(21) Appl. No.: 19/353,428

(22) Filed: Oct. 8, 2025

(30) Foreign Application Priority Data
Oct. 21, 2024 (JP) 2024-185026

(51) Int. Cl. B41J 2/165; B41J 2/14

(52) U.S. Cl. CPC B41J 2/16517; B41J 2/14072; B41J 2/14129; B41J 2002/16561

(57) ABSTRACT

A method for removing kogation, the method includes removing kogation accumulated on a surface of the upper protective layer by applying a voltage in a state where the upper protective layer is used as an anode electrode and a portion connectable to the upper protective layer via the ink is used as a cathode electrode, wherein removing kogation is performed under a first condition including applying the voltage over a first time, and then is performed under a second condition including applying the voltage over a second time longer than the first time.

### BACKGROUND

### Field of the Technology

The aspect of the embodiments relates to a cleaning method and an ink ejection apparatus.

### Description of the Related Art

Widely used among the recording methods adopted in recording apparatuses, such as multifunction printers, is an inkjet recording method, which is a non-impact recording method that enables low-noise, high-density, and high-speed recording. An inkjet ejection apparatus includes a mechanism for driving a carrier equipped with an inkjet head, a conveyance mechanism for conveying a recording medium, such as recording paper, and a control configuration for controlling those mechanisms. In this specification, an inkjet head is also referred to as an “ink ejection head (head)”.

One method of generating energy for ejecting ink from the ejection ports of the ink ejection head is heating ink with an electrothermal conversion unit (hereinafter, also referred to as a “heater”) including a heating resistor, generating bubbles. Ink used in the ink ejection head is often dye-based or pigment-based ink. In the method of ejecting ink using the electrothermal conversion unit, the coloring material may thermally decompose, accumulating on a surface of the heater as inorganic or organic substances, which is referred to as kogation. Kogation can be a factor that prevents thermal conduction from the heater to the ink, causing decrease in the ejection speed of the ink. This results in, for example, thin lines, distorted characters, changes in color, and the like caused by deviation from ink landing positions.

To address this issue, Japanese Patent Laid-Open No. 2008-105364 describes a head that includes an electrically connectable upper protective layer disposed in an area including a heat applying portion of the heater so as to serve as an electrode that generates an electrochemical reaction with ink. In such a head, the surface of the upper protective layer as an anode is dissolved by the electrochemical reaction, which makes it possible to remove kogation accumulated along with a metal that forms the upper protective layer.

However, according to Japanese Patent Laid-Open No. 2008-105364, in removing kogation repeatedly, the kogation removal process under the same condition may gradually result in insufficient removal of kogation. This is because if the kogation cannot be completely removed in one kogation removal process, the amount of kogation accumulated on the heater gradually increases. In this case, the surface condition of the heater changes, and thus, insufficient heat may be conducted to the ink. For example, if the heater is an element that generates energy for ejecting ink from the ejection ports, stable ejection may not be obtained due to a decrease in the ejection speed.

### SUMMARY

According to an aspect of the embodiments, a method for removing kogation accumulated on an upper protective layer of an inkjet head including an electrothermal conversion unit disposed in an ink flow path communicating with an ejection port for ejecting ink, an insulating protective layer for blocking contact between the electrothermal conversion unit and the ink in the ink flow path, and the upper protective layer that covers a portion of the insulating protective layer to be heated by the electrothermal conversion unit, the method includes removing kogation accumulated on a surface of the upper protective layer by applying a voltage in a state where the upper protective layer is used as an anode electrode and a portion connectable to the upper protective layer via the ink is used as a cathode electrode, wherein removing kogation is performed under a first condition including applying the voltage over a first time, and then is performed under a second condition including applying the voltage over a second time longer than the first time.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of a recording apparatus.

FIG. 2 is a schematic diagram illustrating a first circulation path.

FIG. 3 is a schematic diagram illustrating a second circulation path.

FIG. 4A is a bottom perspective view of an ink ejection head. FIG. 4B is a top perspective view of the ink ejection head.

FIG. 5 is an exploded perspective view of the ink ejection head.

FIG. 6A is a top view of an ejection module mounting surface of a first flow path member. FIG. 6B is a top view of a joining surface of the first flow path member to a second flow path member. FIG. 6C is a top view of a joining surface of the second flow path member and the first flow path member. FIG. 6D is a top view of a joining surface of the second flow path member and a third flow path member. FIG. 6E is a top view of a joining surface of the third flow path member and the second flow path member. FIG. 6F is a top view of an abutment surface of the third flow path member and a liquid ejection unit support portion.

FIG. 7 is a diagram illustrating a connection relationship between flow paths in the flow path members.

FIG. 8 is a cross-sectional view taken along the line VIII-VIII in FIG. 7.

FIG. 9A is a perspective view of an ejection module. FIG. 9B is an exploded perspective view of the ejection module.

FIG. 10A is a top view of a recording element substrate. FIG. 10B is an enlarged view of the part Xb in FIG. 10A. FIG. 10C is a top view of the back surface of the recording element substrate.

FIG. 11 is a perspective view of a structure of the recording element substrate and a cover member taken along the cross-sectional line XI-XI in FIG. 10A.

FIG. 12 is a partially enlarged plan view of adjacent portions of the recording element substrates.

FIG. 13A is a top view of a heat applying portion of the recording element substrate. FIG. 13B is a cross-sectional view of the heat applying portion of the recording element substrate.

FIG. 14 is a diagram illustrating change in ejection speed according to a conventional example.

FIG. 15 is a diagram illustrating change in ejection speed according to a first embodiment.

FIG. 16 is a diagram illustrating a modeling of communications between the head and a recording apparatus main body, and between an ink cartridge and the recording apparatus main body.

FIG. 17 is a flowchart illustrating a recording method including a kogation removal process.

### DESCRIPTION OF THE EMBODIMENTS

An embodiment of the disclosure will now be described with reference to the drawings. However, the following description does not unnecessarily limit the scope of the disclosure. The following description is an example of a liquid ejection apparatus with a line-type head having a length corresponding to the width of a recording medium, but the idea of the disclosure can also be applied to a serial-type liquid ejection apparatus that performs recording while scanning a recording medium. An example will be described where a serial-type liquid ejection apparatus includes one recording element substrate for black ink and one recording element substrate for color ink. However, the disclosure is not limited to this configuration. In another configuration, a short line head shorter than the width of the recording medium with several recording element substrates arranged so that ejection ports overlap in an ejection port array direction may be employed to scan the recording medium. The recording apparatus according to the embodiment is a circulating inkjet recording apparatus in which a liquid, such as ink, is circulated between a tank and the liquid ejection apparatus, but a non-recirculating inkjet recording apparatus can be used.

### First Embodiment

### (Inkjet Recording Apparatus)

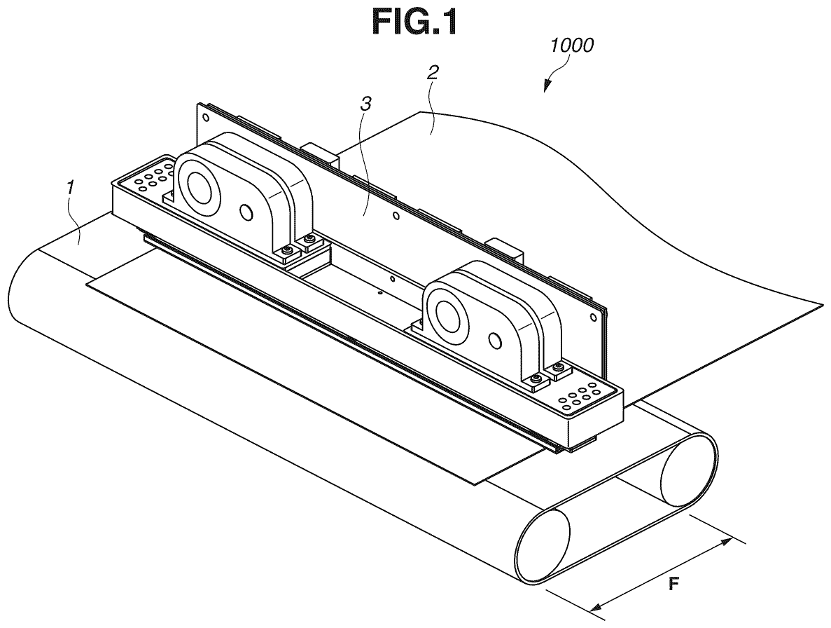

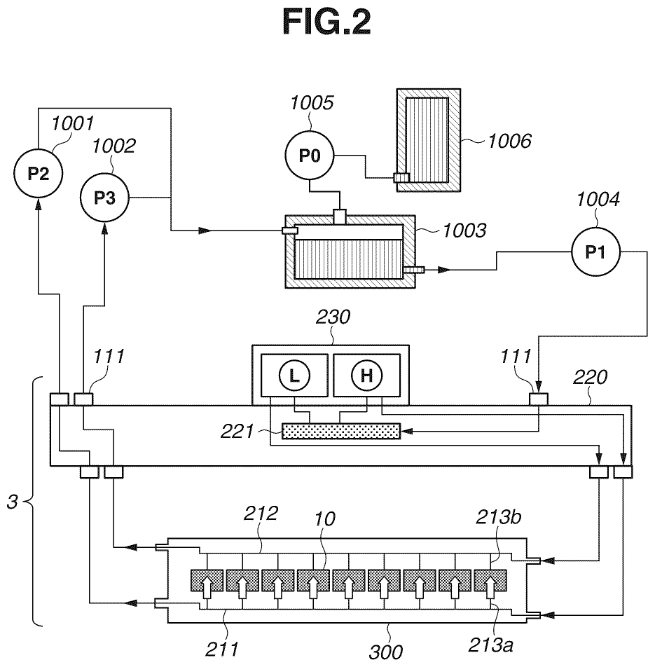

FIG. 1 illustrates a schematic configuration of a liquid ejection apparatus, specifically, an ink ejection apparatus 1000 (hereinafter, also referred to as a recording apparatus) that ejects ink to perform recording according to the embodiment. The recording apparatus is a line-type apparatus including a conveyance unit 1 that conveys a recording medium 2 and a line-type ink ejection head 3 disposed substantially orthogonal to the conveyance direction of the recording medium 2, and performs continuous recording in a single pass while continuously or intermittently conveying the recording medium 2. The recording medium 2 is not limited to a cut sheet, and can be a continuous roll sheet. The ink ejection head 3 is capable of full-color printing with ink of cyan, magenta, yellow, and black (CMYK). In the ink ejection head 3, a liquid supply unit that includes a supply path for supplying ink to the ink ejection head 3 as described below is fluidly connected to a main tank and a buffer tank (see FIG. 2). Further, the ink ejection head 3 is electrically connected to an electric control unit that transmits power and ejection control signals to the ink ejection head 3. The liquid path and the electric signal path in the ink ejection head 3 will be described in the following.

### (First Circulation Path)

FIG. 2 is a schematic diagram illustrating a first circulation path that is one form of a circulation path applied to the recording apparatus according to the embodiment. As illustrated in FIG. 2, the ink ejection head 3 is fluidly connected to a first circulation pump (a high-pressure side) 1001, a first circulation pump (a low-pressure side) 1002, a buffer tank 1003, and the like. For the sake of simplicity of description, FIG. 2 illustrate a path alone through which ink of one color of the CMYK inks flows, but in reality, circulation paths for four colors are arranged in the ink ejection head 3 and the recording apparatus main body.

The buffer tank 1003 as a sub-tank that is connected to a main tank 1006 includes an air communication port (not illustrated) that communicates between the inside and the outside of the tank 1003 to emit air bubbles in the ink to the outside. The buffer tank 1003 is also connected to a refill pump 1005. When ink is consumed in the ink ejection head 3, the refill pump 1005 transfers the amount of ink consumed from the main tank 1006 to the buffer tank 1003. Ink is consumed in the ink ejection head 3, for example, when ink is ejected (emitted) from the ejection ports of the ink ejection head, for recording with the ink ejected, suction recovery, or the like.

The two first circulation pumps 1001 and 1002 are configured to flow ink from liquid connection portions 111 of the ink ejection head 3 to the buffer tank 1003. The first circulation pumps 1001 and 1002 can be positive displacement pumps having a capability of delivery of a fixed amount of ink. Specific examples include tube pumps, gear pumps, diaphragm pumps, and syringe pumps. However, the first circulation pumps can also be used, for example, in a form in which a general constant flow valve or a relief valve is disposed at the pump outlet to maintain a constant flow rate. When the ink ejection head 3 is driven, a certain amount of ink flows into a common supply flow path 211 and a common collection flow path 212 using the first circulation pump (the high-pressure side) 1001 and the first circulation pump (the low-pressure side) 1002. This flow rate can be set so that the temperature difference between recording element substrates 10 in the ink ejection head 3 does not affect recording image quality. However, if the flow rate is set too high, the negative pressure difference becomes too large between the recording element substrates 10 due to the impact of pressure loss in the flow paths within a liquid ejection unit 300, resulting in uneven density in the image. Thus, the flow rate can be set in consideration of the temperature difference and the negative pressure difference between the recording element substrates 10.

A negative pressure control unit 230 is disposed midway on the path connecting a second circulation pump 1004 and the liquid ejection unit 300. Thus, the negative pressure control unit 230 has a function of operating to maintain the pressure downstream of the negative pressure control unit 230 (i.e., the liquid ejection unit 300 side) at a preset constant pressure even if the flow rate in the circulation system fluctuates due to difference in recording duty. As two pressure adjustment mechanisms constituting the negative pressure control unit 230, any mechanisms can be used as long as the mechanisms can control the pressure downstream of the mechanisms within a certain variation range centered around a desired set pressure. As one example, mechanisms similar to “pressure-reducing regulators” can be employed. In the case of using pressure-reducing regulators, the upstream side of the negative pressure control unit 230 can be pressurized by the second circulation pump 1004 via a liquid supply unit 220 as illustrated in FIG. 2. This can reduce the impact of the water head pressure with respect to the buffer tank 1003 on the ink ejection head 3, increasing the degree of freedom in the layout of the buffer tank 1003 in the recording apparatus 1000. The second circulation pump 1004 can be any pump having a pressure corresponding to a pump head equal to or greater than a certain pressure within a range of the ink circulation flow rate used to drive the ink ejection head 3, and a turbo pump, a positive displacement pump, or the like can be used as the second circulation pump 1004. Specifically, a diaphragm pump or the like can be employed. Instead of the second circulation pump 1004, for example, a water head tank arranged with a certain water head difference with respect to the negative pressure control unit 230 can be used.

As illustrated in FIG. 2, the negative pressure control unit 230 includes two pressure adjustment mechanisms that are set to different control pressures. Of the two negative pressure adjustment mechanisms, one negative pressure adjustment mechanism set to a relatively high pressure (indicated as H in FIG. 2) is connected to the common supply flow path 211 in the liquid ejection unit 300 through the liquid supply unit 220. The other set to a relatively low pressure (indicated as L in FIG. 2) is connected to the common collection flow path 212 through the liquid supply unit 220.

The liquid ejection unit 300 includes the common supply flow path 211, the common collection flow path 212, and an individual supply flow path 213a and an individual collection flow path 213b that communicate with each recording element substrate 10. The individual supply flow paths 213a and 213b communicate with the common supply flow path 211 and the common collection flow path 212, and thus, some of the ink flow from the common supply flow path 211 through the internal flow paths of the recording element substrates 10 to the common collection flow path 212 (arrows in FIG. 2). This is because the pressure adjustment mechanism H is connected to the common supply flow path 211, and the pressure adjustment mechanism L is connected to the common collection flow path 212, causing a pressure difference between the two common flow paths.

As described above, in the liquid ejection unit 300, while ink is flown to pass through the common supply flow path 211 and the common collection flow path 212, some of the ink flow through each recording element substrate 10. Thus, the heat generated in each recording element substrate 10 can be exhausted to the outside of the recording element substrate 10 through the common supply flow path 211 and the common collection flow path 212. This configuration allows ink to flow even in the ejection ports and the pressure chambers that are not being used in performing recording while a recording is being performed using the ink ejection head 3, reducing thickening of the ink in the ejection ports and the pressure chambers. Further, this configuration allows thickened ink and foreign matter in the ink to be discharged to the common collection flow path 212. Thus, the ink ejection head 3 of the embodiment can perform high-speed and high-quality recording.

### (Second Circulation Path)

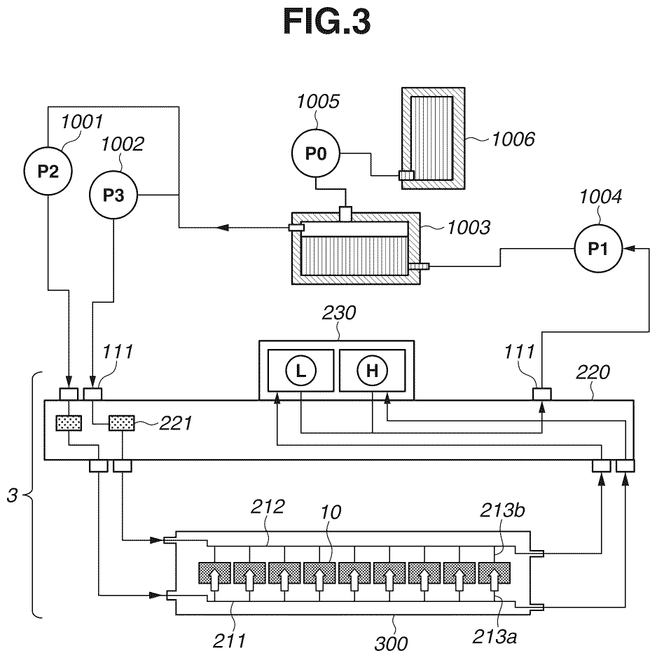

FIG. 3 is a schematic diagram illustrating a second circulation path, which is different from the first circulation path described above, among the circulation paths applied to the recording apparatus according to the embodiment. The main differences from the first circulation path are as described in the following.

First, both of the two pressure adjustment mechanisms constituting the negative pressure control unit 230 include mechanisms (mechanical components perform the same operation as “back-pressure regulators”) that control the pressure upstream of the negative pressure control unit 230 within a certain variation range centered around a desired set pressure. The second circulation pump 1004 acts as a negative pressure source that reduces the pressure downstream of the negative pressure control unit 230. The first circulation pump (the high-pressure side) 1001 and the first circulation pump (the low-pressure side) 1002 are disposed upstream of the ink ejection head 3, and the negative pressure control unit 230 is disposed downstream of the ink ejection head 3.

The negative pressure control unit 230 in the second circulation path operates so that the pressure fluctuation upstream of the negative pressure control unit 230 (i.e., the liquid ejection unit 300 side) is within a certain range even if the flow rate fluctuates due to change in the duty during recording by using the ink ejection head 3. The pressure fluctuation is within, for example, a certain range centered around a preset pressure. As illustrated in FIG. 3, the downstream side of the negative pressure control unit 230 can be pressurized by the second circulation pump 1004 via the liquid supply unit 220. This can reduce the impact of the water head pressure in the buffer tank 1003 with reference to the ink ejection head 3, increasing the degree of freedom in the layout of the buffer tank 1003 in the printing apparatus 1000. Instead of the second circulation pump 1004, for example, a water head tank with a predetermined water head difference with respect to the negative pressure control unit 230 can be used.

As in the first circulation path, the negative pressure control unit 230 illustrated in FIG. 3 includes two pressure adjustment mechanisms that are set to different control pressures. Of the two negative pressure adjustment mechanisms, one negative pressure adjustment mechanism set to a relatively high pressure (indicated as H in FIG. 3) is connected to the common supply flow path 211 in the liquid ejection unit 300 through the liquid supply unit 220. The other set to a relatively low pressure (indicated as L in FIG. 3) is connected to the common collection flow path 212 through the liquid supply unit 220.

The two negative pressure adjustment mechanisms maintain the pressure in the common supply flow path 211 at a level relatively higher than the pressure in the common collection flow path 212. This configuration causes ink to flow from the common supply flow path 211 through the individual flow paths 213 and the internal flow path of each recording element substrate 10 to the common collection flow path 212 (arrows in FIG. 3). In this manner, in the second circulation path, an ink flow state similar to that of the first circulation path is generated in the liquid ejection unit 300, but there are two different advantages from the first circulation path.

The first advantage is that the negative pressure control unit 230 is disposed downstream of the ink ejection head 3 in the second circulation path, which reduces the risk of debris or foreign matter generated from the negative pressure control unit 230 flowing into the head. The second advantage is that, in the second circulation path, the maximum flow rate required to supply ink from the buffer tank 1003 to the ink ejection head 3 is lower than that in the first circulation path. The reason for this as follows. Let A denote the total flow rate in the common supply flow path 211 and the common collection flow path 212 in the case of circulation during standby for recording. The value of A is defined as the minimum flow rate required to maintain the temperature difference in the liquid ejection unit 300 within a desired range in adjusting the temperature in the ink ejection head 3 during standby for recording. Let F denote the ejection flow rate in the case of ejecting ink from all ejection ports of the liquid ejection unit 300 (full ejection). In the first circulation path (FIG. 2), the set flow rates in the first circulation pump (the high-pressure side) 1001 and in the first circulation pump (the low-pressure side) 1002 are A, and thus, the maximum amount of liquid required to supply to the ink ejection head 3 during full ejection is A+F.

On the other hand, in the second circulation path (FIG. 3), the amount of liquid required to supply to the ink ejection head 3 during standby for recording is the flow rate A. The amount of liquid required to supply to the ink ejection head 3 during full ejection is the flow rate F. Then, in the second circulation path, the total value of the set flow rates in the first circulation pump (the high-pressure side) 1001 and the first circulation pump (the low-pressure side) 1002, i.e., the maximum value of the required supply flow rate, is the larger value of A and F. As long as the liquid ejection unit 300 having the same configuration is used, the maximum value of the required supply amount (A or F) in the second circulation path is always smaller than the maximum value of the required supply amount (A+F) in the first circulation path. Thus, in the second circulation path, the degree of freedom of the applicable circulation pumps increases. This makes it possible to use, for example, low-cost circulation pumps with simple configurations, or to reduce load on a cooler (not illustrated) installed in a path on the recording apparatus main body side, providing the advantage of reducing cost of the recording apparatus main body. This advantage is more significant in a line head where the value of A or F is relatively large, and is more beneficial for line heads that are longer in the longitudinal length among the line heads.

However, the first circulation path has some advantages over the second circulation path. Specifically, in the second circulation path, the flow rate through the liquid ejection unit 300 during standby for recording is maximized, which results in higher negative pressure being applied to each nozzle as the recording duty decreases. Thus, especially when the flow path widths (the lengths in the direction orthogonal to the ink flow direction) of the common supply flow path 211 and the common collection flow path 212 are reduced to decrease the head width (the length in the shorter direction of the ink ejection head), high negative pressure is applied to the nozzles in forming a low-duty image where unevenness is easily visible. The application of such high negative pressure may increase the impact of satellite droplets. On the other hand, in the first circulation path, high negative pressure is applied to the nozzles at the time of formation of a high-duty image, and thus, there is an advantage that, even if satellite droplets occur, the satellite droplets are difficult to see, resulting in small impact on the printed image. A desired one of the two circulation paths can be selected in light of the specifications of the ink ejection head and the recording apparatus main body (the ejection flow rate F, the minimum circulation flow rate A, and the flow path resistance within the head).

### (Configuration of Ink Ejection Head)

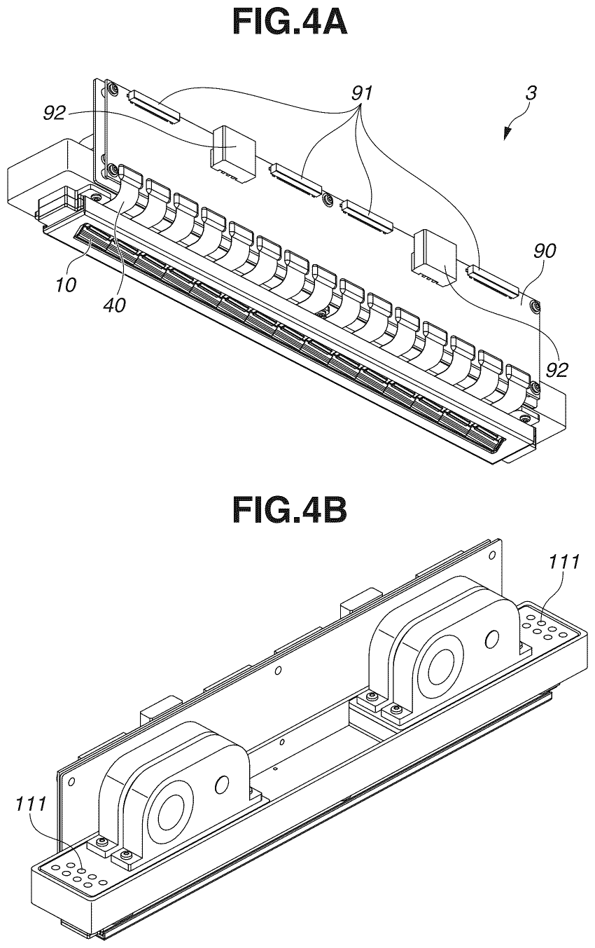

A configuration of the ink ejection head 3 according to the first embodiment will be described. FIGS. 4A and 4B are perspective views of the ink ejection head 3 according to the embodiment. The ink ejection head 3 is a line-type ink ejection head in which 15 recording element substrates 10 capable of ejecting ink of four colors, C/M/Y/K, are arranged in a straight line (arranged in-line).

As illustrated in FIG. 4A, the ink ejection head 3 includes signal input terminals 91 and power supply terminals 92 that are electrically connected to the recording element substrates 10 via flexible wiring board 40 and an electric wiring board 90. The signal input terminals 91 and the power supply terminals 92 are electrically connected to a control unit of the recording apparatus 1000, ejection drive signals are supplied to the recording element substrates 10 via the signal input terminals 91, and power required for ejection is supplied to the recording element substrates 10 via the power supply terminals 92.

The wiring is gathered through the electrical circuity in the electric wiring board 90, and thus, the numbers of the signal output terminals 91 and the power supply terminals 92 can be smaller than the number of the recording element substrates 10. This reduces the number of electrical connections that need to be removed at the time of assembling the ink ejection head 3 to the recording apparatus 1000 or replacing the ink ejection head 3. As illustrated in FIG. 4B, the liquid connection portions 111 disposed at both ends of the ink ejection head 3 are connected to the liquid supply system of the recording apparatus 1000. This configuration allows the ink of four colors, CMYK, to be supplied from the supply system of the recording apparatus 1000 to the ink ejection head 3, and the ink that has passed through the ink ejection head 3 to be collected into the supply system of the recording apparatus 1000. In this manner, the ink of each color can be circulated through the path of the recording apparatus 1000 and the path of the ink ejection head 3.

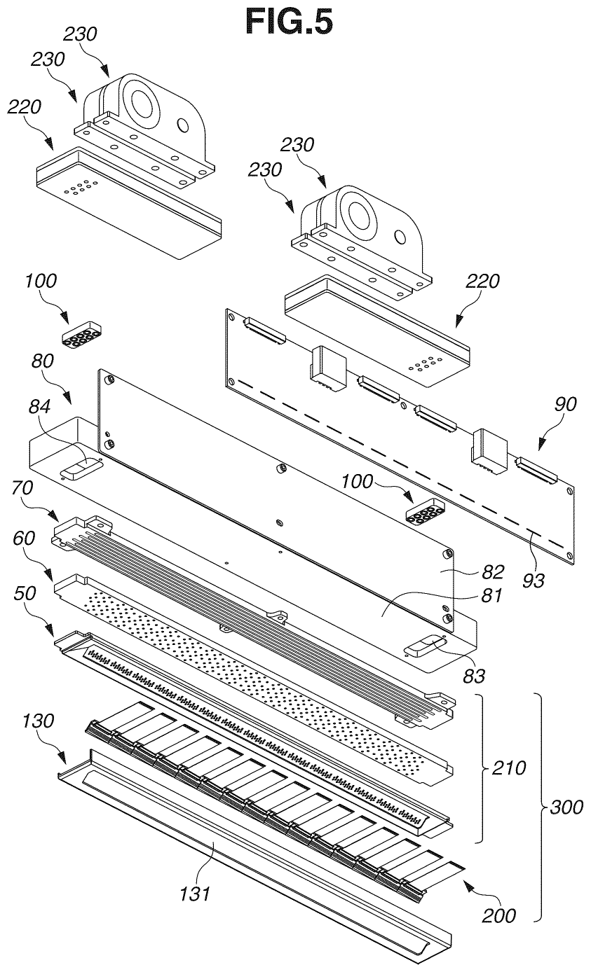

FIG. 5 is an exploded perspective view of components or units constituting the ink ejection head 3. The liquid ejection unit 300, the liquid supply units 220, and the electric wiring board 90 are attached to a housing 80. Each liquid supply unit 220 includes the liquid connection portions 111 (FIGS. 2 and 3), and filters 221 (FIGS. 2 and 3) for each color that communicates with the openings of the liquid connection portions 111 in order to remove foreign matter from the supplied ink. Each of the two liquid supply units 220 is provided with the filters 221 for two respective colors. The ink that has passed through the filters 221 is supplied to the negative pressure control unit 230 disposed on the liquid supply unit 220 for each color.

Each negative pressure control unit 230 includes pressure adjustment valves for the color. The negative pressure control unit 230 significantly attenuates the pressure loss change in the supply system of the recording apparatus 1000 (the supply system upstream of the ink ejection head 3) generated due to fluctuation of the ink flow rate caused by the action of valves, spring members, and the like inside the negative pressure control unit 230. Thus, the negative pressure control unit 230 can stabilize the negative pressure change downstream of the pressure control unit (the liquid ejection unit 300 side) within a certain range. As illustrated in FIG. 2, the negative pressure control unit 230 for each color includes two pressure adjustment valves for the color therein. These pressure adjustment valves are set to different control pressures, and the high-pressure one communicates with the common supply flow path 211 in the liquid ejection unit 300, and the low-pressure one communicates with the common collection flow path 212, via the liquid supply unit 220.

The housing 80 includes a liquid ejection unit support part 81 and an electric wiring board support part 82 to support the liquid ejection unit 300 and the electric wiring board 90 while maintaining the rigidity of the ink ejection head 3. The electric wiring board support part 82 is configured to support the electric wiring board 90, and is fixed by screwing to the liquid ejection unit support part 81. The liquid ejection unit support part 81 corrects warp and deformation of the liquid ejection unit 300 to ensure the accuracy of relative positions between the plurality of recording element substrates 10, reducing the occurrence of streaks and unevenness in the recorded products. For this reason, in one embodiment, the liquid ejection unit support part 81 has sufficient rigidity, and to be made of a metal material, such as steel use stainless (SUS) or aluminum, or a ceramic, such as alumina. The liquid ejection unit support part 81 is provided with openings 83 and 84 into which joint rubbers 100 are inserted. The ink supplied from the liquid supply units 220 is led to a third flow path member 70 included in the liquid ejection unit 300 via the joint rubbers 100.

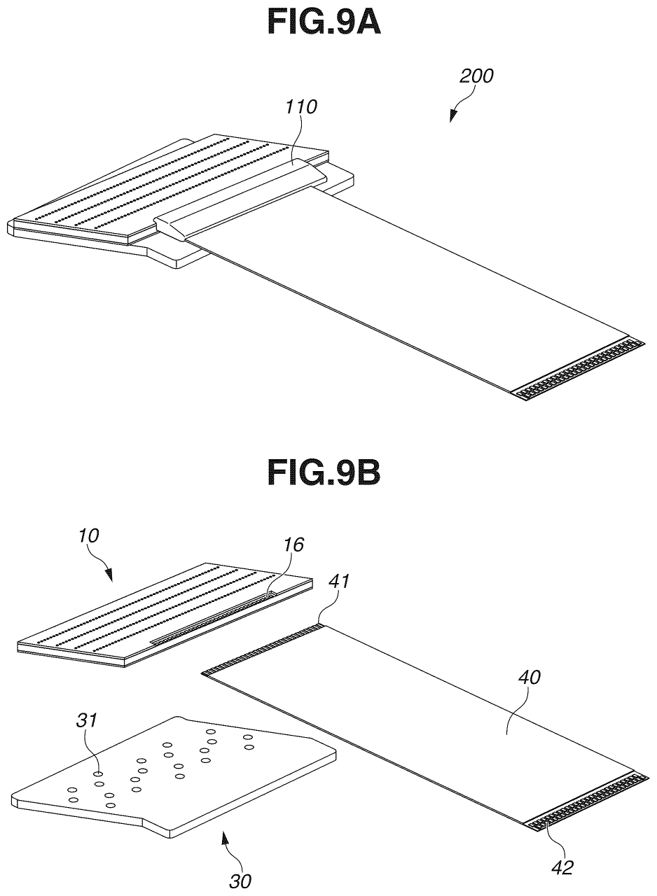

The liquid ejection unit 300 includes a plurality of ejection modules 200 and a flow path member 210. A cover member 130 is attached to the surface of the liquid ejection unit 300 on the recording medium side. As illustrated in FIG. 5, the cover member 130 here has a frame-shaped surface with a long opening 131. The recording element substrates 10 and a sealant 110 (FIGS. 9A and 9B) included in the ejection module 200 are exposed from the opening 131. The frame part around the opening 131 functions as the contact surface of a cap member that caps the ink ejection head 3 during standby for recording. For this reason, an adhesive, sealant, filler, or the like can be applied to the periphery of the opening 131 to fill irregularities and gaps in the ejection port surface of the liquid ejection unit 300, which forms a closed space on the ejection port surface of the liquid ejection unit 300 in capping.

A configuration will be described of the flow path member 210 included in the liquid ejection unit 300. As illustrated in FIG. 5, the flow path member 210 is formed by laminating a first flow path member 50, a second flow path member 60, and a third flow path member 70. The flow path member 210 distributes the ink supplied from the liquid supply unit 220 to each ejection module 200, and returns the circulating ink from each ejection module 200 to the liquid supply units 220. The flow path member 210 is fixed by screwing to the liquid ejection unit support part 81, preventing warp and deformation of the flow path member 210.

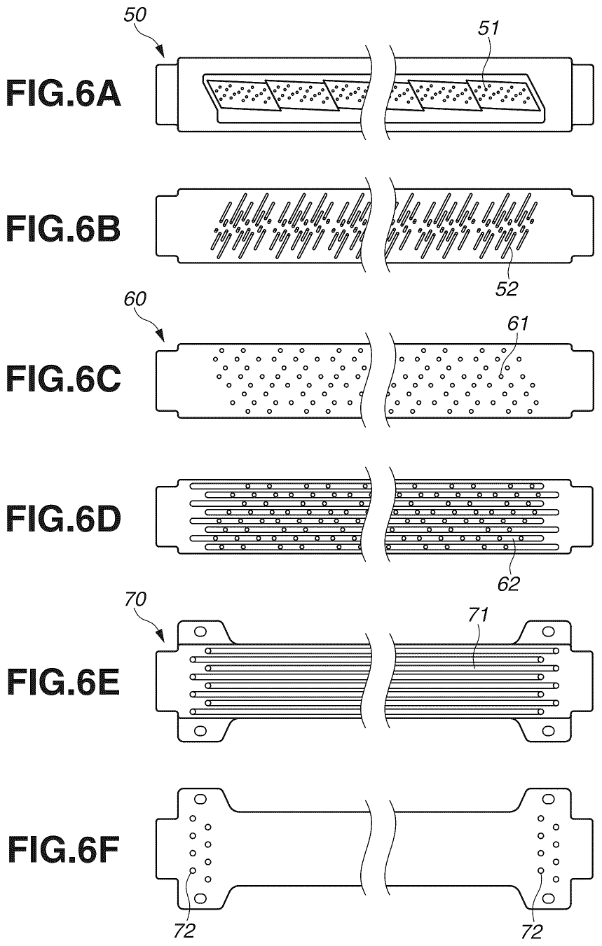

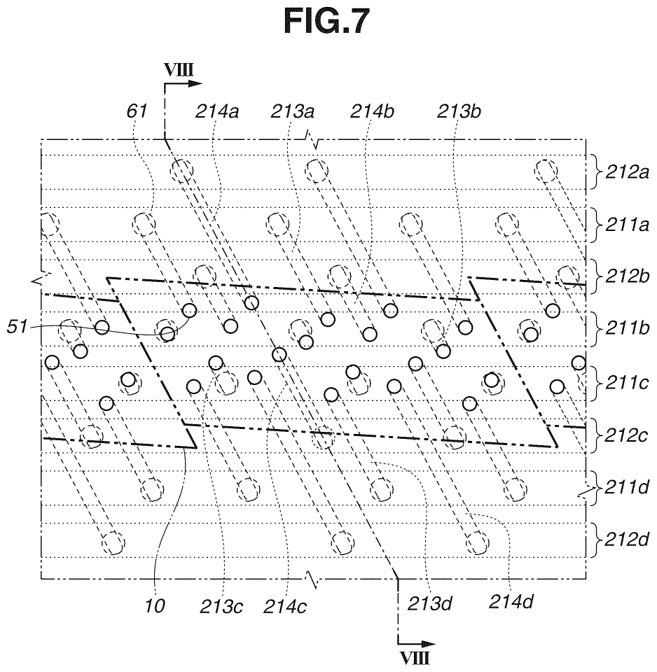

FIGS. 6A, 6B, 6C, 6D, 6E and 6F are diagrams illustrating the front and back surfaces of the first to the third flow path members. FIG. 6A illustrates the surface of the first flow path member 50 on which the ejection modules 200 are to be mounted, and FIG. 6F illustrates the surface of the third flow path member 70 with which the liquid ejection unit support part 81 is to be in contact. The first flow path member 50 and the second flow path member 60 are joined so that the surface illustrated in FIG. 6B and the surface illustrated in FIG. 6C, which are the respective abutment surfaces of the flow path members, face each other. The second flow path member 60 and the third flow path member 70 are joined so that the surface illustrated in FIG. 6D and the surface illustrated in FIG. 6E, which are the respective abutment surfaces of the flow path members, face each other. Joining the second flow path member 60 and the third flow path member 70 forms eight common flow paths that extend in the longitudinal direction of the flow path members with common flow path grooves 62 and common flow path grooves 71 formed in the flow path members. In this way, as illustrated in FIG. 7, a set of the common supply flow path 211 and the common collection flow path 212 is formed for each color in the flow path member 210. Communication ports 72 in the third flow path member 70 communicate with the holes of the joint rubbers 100, which fluidically communicate with the liquid supply unit 220. A plurality of communication ports 61 formed in the bottom surface of the common flow path grooves 62 in the second flow path member 60 communicates with one end of each individual flow path groove 52 in the first flow path member 50. Communication ports 51 formed in the other end of each individual flow path groove 52 in the first flow path member 50 fluidically communicate with the plurality of ejection modules 200 via the communication ports 51. The individual flow path grooves 52 make it possible to gather the flow paths toward the center of the flow path member.

The first to third flow path members can be each made of a material that has corrosion resistant to liquid and has a low linear expansion coefficient. As an example of a suitable material, a composite material (a resin material) made of a base material, such as alumina, liquid crystal polymer (LCP), polyphenylene sulfide (PPS), or polysulfone (PSF) mixed with an inorganic filler, such as silica particles or fibers. The flow path member 210 can be formed by laminating the three flow path members to bond the members to each other. If a resin-based composite material is selected as the material, the three flow path members can be joined by welding.

The connection relationship between flow paths in the flow path member 210 will now be described with reference to FIG. 7. FIG. 7 is a perspective view of flow paths in the flow path member 210 formed by joining the first to third flow path members, partially enlarged from the side of the surface of the first flow path member 50 on which the ejection modules 200 are to be mounted. The flow path member 210 includes the common supply flow path 211 (211a, 211b, 211c, and 211d) and the common collection flow path 212 (212a, 212b, 212c, and 212d) that extend in the longitudinal direction of the ink ejection head 3 for each color. A plurality of individual supply flow paths (213a, 213b, 213c, and 213d) formed of the individual flow path grooves 52 is connected to the common supply flow path 211 for each color via the communication ports 61. Further, a plurality of individual collection flow paths (214a, 214b, 214c, and 214d) formed of the individual flow path grooves 52 is connected to the common collection flow path 212 for each color via the communication ports 61. This flow path configuration allows the ink to be gathered from the common supply flow path 211 via the individual supply flow paths 213 to the recording element substrates 10 positioned in the central area of the flow path member 210. Further, the ink can be collected from the recording element substrates 10 via the individual collection flow paths 214 to the common collection flow path 212.

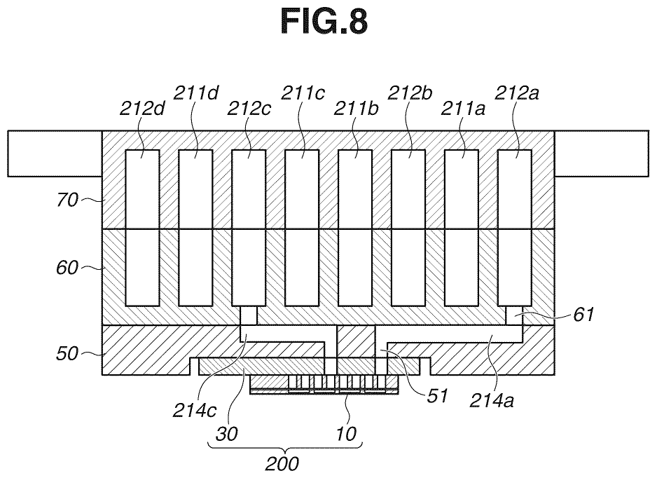

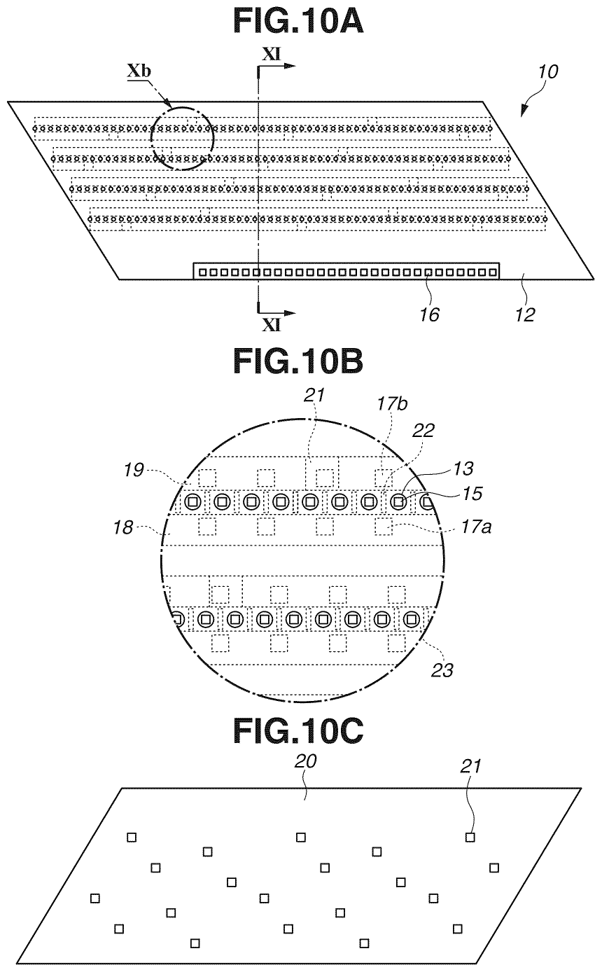

FIG. 8 is a cross-sectional view taken along the line VIII-VIII in FIG. 7. As illustrated in FIG. 8, the individual collection flow paths (214a and 214c) communicate with the ejection modules 200 via the communication ports 51. While FIG. 8 illustrates only the individual collection flow paths (214a and 214c), the individual supply flow paths 213 communicate with the ejection modules 200 in another cross section as illustrated in FIG. 7. A flow path is formed in a support member 30 and a recording element substrate 10 included in each ejection module 200 to supply the ink from the first flow path member 50 to recording elements 15 (FIG. 10B) provided on the recording element substrate 10. Further, a flow path is formed in a support member 30 and a recording element substrate 10 to collect (return) some or all of the ink supplied to the recording elements 15 into the first flow path member 50. The common supply flow path 211 for each color is connected to the negative pressure control unit 230 (the high-pressure side) for the color via the liquid supply unit 220, and the common collection flow path 212 is connected to the negative pressure control unit 230 (the low-pressure side) via the liquid supply unit 220. The negative pressure control unit 230 is configured to generate a differential pressure (a pressure difference) between the common supply flow path 211 and the common collection flow path 212. For this reason, in the ink ejection head of the embodiment in which the flow paths are connected as illustrated in FIGS. 7 and 8, ink flows from the common supply flow path 211 through the individual supply flow path 213a, the recording element substrates 10, and the individual collection flow path 213b to the common collection flow path 212 for the respective colors.

### (Ejection Module)

FIG. 9A illustrates a perspective view of one ejection module 200, and FIG. 9B illustrates an exploded view of the ejection module 200. In a manufacturing method for the ejection module 200, first, a recording element substrate 10 and a flexible wiring board 40 are bonded to a support member 30 in which liquid communication ports 31 are provided in advance. After that, a terminal 16 on the recording element substrate 10 and a terminal 41 on the flexible wiring board 40 are electrically connected by wire bonding, and then the wire-bonded portion (an electrical connection portion) is covered and sealed with the sealant 110. A terminal 42 on the flexible wiring board 40 opposite to the recording element substrate 10 is electrically connected to a connection terminal 93 (see FIG. 5) on the electrical wiring board 90. The support member 30 is a support body that supports the recording element substrate 10 and is also a flow path member that fluidly communicates the recording element substrate 10 and the flow path member 210. For that reason, in one embodiment, the support member 30 has high flatness which can be joined to the recording element substrate 10 with sufficiently high reliability. As the material, in one embodiment, alumina or a resin material is used.

### (Structure of Recording Element Substrate)

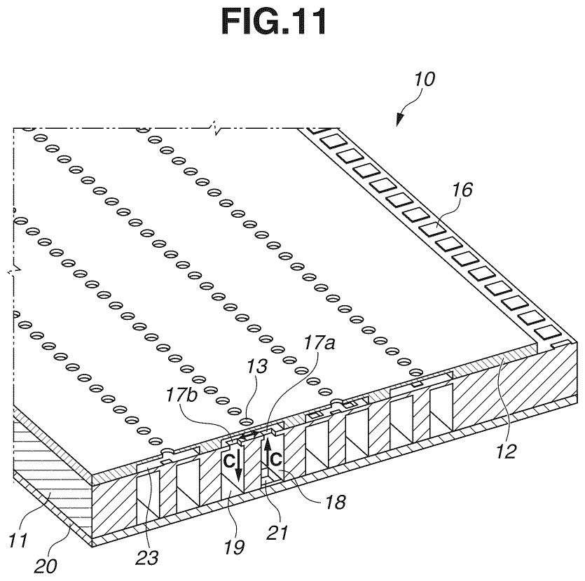

A configuration will be described of a recording element substrate 10 in the embodiment. FIG. 10A is a plan view of the surface of the recording element substrate 10 where ejection ports 13 are formed. FIG. 10B is an enlarged view of the portion indicated as Xb in FIG. 10A. FIG. 10C is a plan view of the back of the surface illustrated in FIG. 10A. FIG. 11 is a perspective view of a cross section of the recording element substrate 10 and a cover member 20 taken along the line XI-XI illustrated in FIG. 10A. As illustrated in FIG. 10A, four ejection port arrays corresponding to the respective ink colors are formed in an ejection port forming member 12 of the recording element substrate 10. Hereinafter, a direction in which the plurality of arrays of ejection ports 13 extend is referred to as an “ejection port array direction”.

As illustrated in FIG. 10B, the recording elements 15, which are heating elements for generating bubbles in the ink by thermal energy, are disposed at positions corresponding to the ejection ports 13. Pressure chambers 23 having the recording elements 15 therein are partitioned by partition walls 22. The recording elements 15 are electrically connected to the terminals 16 in FIG. 10A by electric wiring (not illustrated) provided on the recording element substrate 10. A recording element 15 generates heat based on a pulse signal input from a control circuit of the recording apparatus 1000 via the electric wiring board 90 (FIG. 5) and the flexible wiring board 40 (FIGS. 9A and 9B) to boil the ink. The ink is ejected from the corresponding ejection port 13 by the force of a bubble generated by this boiling. As illustrated in FIG. 10B, a liquid supply path 18 extends on one side along each ejection port array, and a liquid collection path 19 extends on the other side. The liquid supply paths 18 and the liquid collection paths 19 are flow paths extending in the ejection port array direction in the recording element substrate 10, and communicate with the ejection ports 13 via supply ports 17a and collection ports 17b, respectively.

As illustrated in FIGS. 10C and 11, the sheet-like cover member 20 is laminated on the back surface of the recording element substrate 10 where the ejection ports 13 are formed. The cover member 20 is provided with a plurality of openings 21, which will be described in the following, communicating with the liquid supply paths 18 and the liquid collection paths 19. In the embodiment, three openings 21 are provided in the cover member 20 for each liquid supply path 18, and two openings 21 are provided in the cover member 20 for each liquid collection path 19. As illustrated in FIG. 10B, the openings 21 in the cover member 20 communicate with the plurality of communication ports 51 illustrated in FIG. 7 and other drawings. As illustrated in FIG. 11, the cover member 20 functions as a cover that forms part of the walls of the liquid supply paths 18 and the liquid collection paths 19 on a substrate 11 of the recording element substrate 10. In one embodiment, the cover member 20 has sufficient corrosion resistance to ink, and from the viewpoint of preventing color mixing, high accuracy is required for the shape and the positions of the openings 21. For this reason, in one embodiment, a photosensitive resin material or a silicon plate is used as the material for the cover member 20, and to provide the openings 21 by a photolithography process. In this manner, the cover member 20 changes pitches of the flow paths by using the openings 21. Considering pressure loss, in one embodiment, the cover member 20 is made of a film-like material, whose thickness is thin.

A flow of ink in a recording element substrate 10 will now be described. FIG. 11 is a perspective cross-sectional view of the recording element substrate 10 and the cover member 20 taken along the line XI-XI in FIG. 10A. The recording element substrate 10 is formed by laminating the substrate 11 made of silicon (Si) and the ejection port forming member 12 made of a photosensitive resin, and the cover member 20 is bonded to the back surface of the substrate 11. The recording elements 15 are formed on one surface of the substrate 11 (FIG. 10B), and grooves constituting the liquid supply paths 18 and the liquid collection paths 19 that extend along the ejection port arrays are formed in the back surface of the substrate 11. The liquid supply paths 18 and the liquid collection paths 19 formed of the substrate 11 and the cover member 20 are connected to the common supply flow path 211 and the common collection flow path 212 in the flow path member 210, respectively, and a pressure difference is generated between each liquid supply path 18 and each liquid collection path 19. When ink is ejected from a plurality of ejection ports 13 of the ink ejection head 3 to perform recording, the ink flows in the liquid supply path 18 on the substrate 11 as indicated by arrows C in FIG. 11 due to the pressure difference in the ejection ports that are not performing the ejection operation. Specifically, the ink flows to the liquid collection path 19 via the supply port 17a, the pressure chamber 23, and the collection port 17b. In the ejection ports 13 and the pressure chambers 23 that are not being used for the recording, this flow collects ink with increased viscosity caused by evaporation through the ejection ports 13, bubbles, foreign matter, and the like into the liquid collection path 19. Further, the flow can prevent ink viscosity from being increased in the ejection ports 13 and the pressure chambers 23. The ink collected in the liquid collection paths 19 is then collected into the communication ports 51 in the flow path member 210, the individual collection flow path 214, and the common collection flow path 212 in that order through the openings 21 in the cover member 20 and the liquid communication ports 31 in the support members 30 (see FIG. 9B). This ink is finally collected into the supply flow path of the recording apparatus 1000.

Thus, the ink supplied from the recording apparatus main body to the ink ejection head 3, is flown, supplied, and collected in the order described in the following. The ink first flows into the ink ejection head 3 via the liquid connection portions 111 of the liquid supply unit 220. The ink is then supplied to the joint rubbers 100, the communication ports 72 and the common flow path grooves 71 in the third flow path member 70, the common flow path grooves 62 and the communication ports 61 in the second flow path member 60, and the individual flow paths 52 and the communication ports 51 in the first flow path member 50. Thereafter, the ink is supplied to the pressure chambers 23 via the liquid communication ports 31 in the support members 30, the openings 21 in the cover member 20, the liquid supply paths 18 and the supply ports 17a in the substrate 11, in that order. Of the ink supplied to the pressure chambers 23, the ink that has not been ejected from the ejection ports 13 flows through the collection ports 17b and the liquid collection paths 19 in the substrate 11, the openings 21 in the cover member 20, and the liquid communication ports 31 in the support members 30, in that order. After that, the ink flows through the communication ports 51 and the individual flow paths 52 in the first flow path member 50, the communication ports 61 and the common flow paths 62 in the second flow path member 60, the common flow paths 71 and the communication ports 72 in the third flow path member 70, and the joint rubbers 100, in that order. Further, the ink flows from the liquid connection portions 111 in the liquid supply unit 220 to the outside of the ink ejection head 3. In the configuration of the first circulation path illustrated in FIG. 2, the ink having flown in from the liquid connection portions 111 passes through the negative pressure control unit 230 to be supplied to the joint rubbers 100. In the configuration of the second circulation path illustrated in FIG. 3, the ink having been collected from the pressure chambers 23 passes through the joint rubbers 100, and then flows from the liquid connection portions 111 to the outside of the ink ejection head 3 via the negative pressure control unit 230.

As illustrated in FIGS. 2 and 3, not all of the ink having flown in from one end of the common supply flow path 211 of the liquid ejection unit 300 is supplied to the pressure chambers 23 via the individual supply flow paths 213a. Some of the ink flows from the other end of the common supply flow path 211 to the liquid supply unit 220 without flowing into the individual supply flow paths 213a. Thus, paths provided in which the ink flows without passing through the recording element substrates 10 makes it possible to prevent backflow of the circulating ink even in the case of the recording element substrates 10 having fine flow paths with large flow resistances as in the embodiment. In this manner, the ink ejection head of the embodiment can prevent the viscosity of the ink from being increased in the pressure chambers or in the vicinity of the ejection ports. Consequently, deviation of the ink ejection from the normal direction and non-discharge can be reduced, which results in high-quality printing.

(Positional Relationship between Recording Element Substrates)

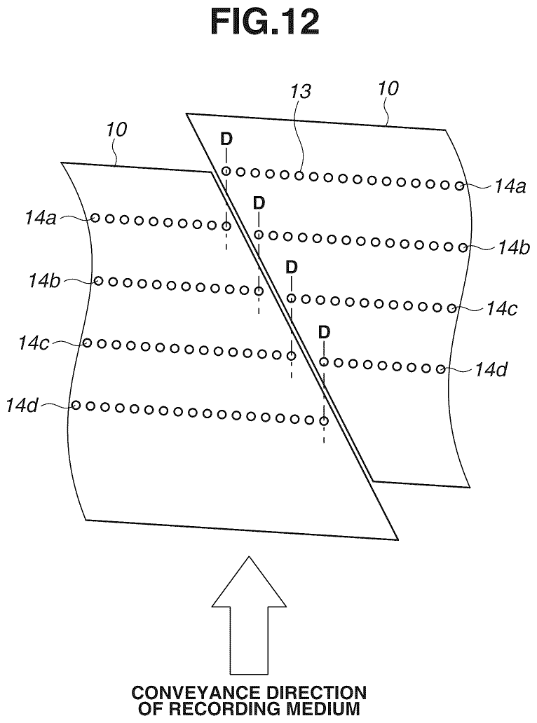

FIG. 12 is a plan view of partially enlarged adjacent portions of the recording element substrates in two adjacent ejection modules. As illustrated in FIG. 10A and other drawings, in the embodiment, recording element substrates having a substantially parallelogram shape are used. As illustrated in FIG. 12, the ejection port arrays (14a to 14d) of the ejection ports 13 are arranged in each recording element substrate 10 obliquely at a certain angle with respect to the conveyance direction of the recording medium. In this configuration, at least one ejection port of each ejection port array in one of the adjacent portions of the recording element substrates 10 overlap with at least one ejection port of the corresponding ejection port array in the other of the adjacent portion in the conveyance direction of the recording medium. In FIG. 12, two ejection ports on a line D overlap with each other. With this arrangement, even if the positions of the recording element substrates 10 are slightly shifted from their predetermined positions, black stripes and white spots in recorded images can be made less noticeable by driving control of the overlapping ejection ports. Even in a case where a plurality of recording element substrates 10 is arranged in a straight line (in-line) instead of in a staggered arrangement, the configuration as illustrated in FIG. 12 can be employed. This serves as a countermeasure against black streaks and white spots at the joints between the recording element substrates 10 without increase in the length of the ink ejection head 3 in the conveyance direction of the recording medium. While the principal plane of the recording element substrates is a parallelogram here, the embodiment is not limited to that. The configuration of the embodiment can also be applied to recording element substrates having a rectangular, trapezoidal, or another shape.

(Structure of Heat Applying portion in Recording Element Substrate)

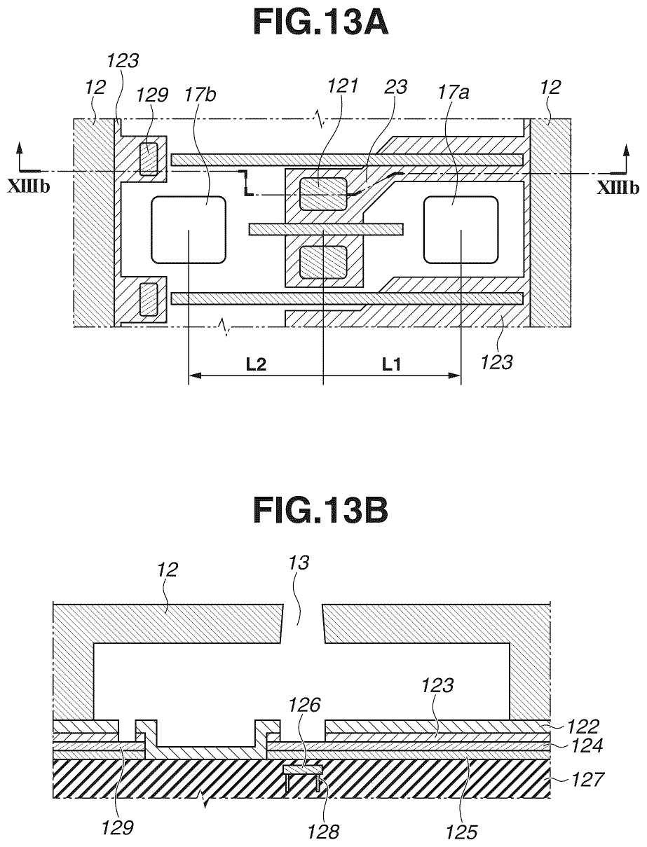

A structure of a heat applying portion in a recording element substrate 10 according to the embodiment will now be described with reference to FIGS. 13A and 13B. FIG. 13A is a schematic enlarged plan view of the heat applying portion and its surroundings in the recording element substrate 10. FIG. 13B is a cross-sectional view taken along the dashed line XIIIb-XIIIb in FIG. 13A.

In the ink ejection head 3, a liquid ejection recording substrate is formed by laminating a plurality of layers on a base 121 formed of silicon. In the embodiment, a heat storage layer formed of a thermal oxide film, a SiO film, a SiN film, or the like is disposed on the base 121. A heating resistor 126, which is an electrothermal conversion unit, is disposed on the heat storage layer, and an electrode wiring layer (not illustrated) formed of a metal material, such as aluminum (Al), aluminum-silicon alloy (Al—Si), or aluminum-copper alloy (Al—Cu), is connected to the heating resistor 126 via a tungsten plug 128. As illustrated in FIG. 13B, an insulating protective layer 127 is disposed on the heating resistor 126 to block contact between the heating resistor 126, which is the electrothermal conversion unit, and the ink in the ink flow path. The insulating protective layer 127 is an insulating layer arranged on the heating resistor 126 so that the insulating protective layer 127 covers the heating resistor 126. The insulating protective layer 127 is formed of a SiO film, a SiN film, or the like. The electrothermal conversion unit is disposed in an ink flow path communicating with the ink ejection ports.

A protective layer for blocking contact with liquid is disposed on the insulating protective layer 127. The protective layer includes a lower protective layer 125, an upper protective layer 124, and an adhesive protective layer 123 to protect the surface of the heating resistor 126 from chemical and physical effects caused by heat generation by the heating resistor 126. The upper protective layer 124 is formed at a position that covers at least the portion to be heated by the electrothermal conversion unit.

In the embodiment, the lower protective layer 125 is formed of tantalum (Ta), the upper protective layer 124 is formed of iridium (Ir), and the adhesive protective layer 123 is formed of tantalum (Ta). The protective layers formed of these materials have conductivity. A protective layer 122 is disposed on the adhesive protective layer 123 to increase liquid resistance and adhesion to the ejection port forming member 12. The protective layer 122 is formed of SiC. In one embodiment, the upper protective layer 124 is formed of a material that contains a metal that dissolves by electrochemical reaction and that does not form an oxide film that prevents dissolution by heating, i.e., a material that contains Ir or ruthenium (Ru).

During ejection of liquid, the upper part of the upper protective layer 124 is in contact with the liquid, and the temperature of the liquid rises instantaneously at the upper part, generating a bubble, which then disappears, causing cavitation, meaning that the upper part is in a harsh environment. Thus, in the embodiment, the upper protective layer 124 formed of an iridium material, which has high corrosion resistance and high reliability, is formed at a position corresponding to the heating resistor 126 and is in contact with the liquid.

In the embodiment, an ink circulation configuration is employed inside a pressure chamber 23 in which liquid is supplied from a supply port 17a and the liquid is collected into a collection port 17b. Thus, during printing, the liquid flows over the heating resistor 126 from the supply port 17a on the upstream side to the collection port 17b on the downstream side.

### (Cleaning Method)

First, a generation principle of kogation and a cleaning method will be described. In the ink ejection head 3, heat from an electrothermal conversion unit (the heater) acts on ink in a pressure chamber 23, causing the ink to be ejected from the ejection port. The ink ejection head 3 ejects ink many times, and thus, the electrothermal conversion unit is heated many times. Consequently, components of the ink accumulate on the upper protective layer 124 due to the heating, resulting in kogation. The kogation prevents the thermal conduction from the electrothermal conversion unit to the ink, causing decrease in the speed of ink ejection from the ink ejection head 3.

A kogation removal process is performed as a cleaning method for removing kogation accumulated on the upper protective layer 124. The kogation removal process is performed by applying a voltage so that a portion of the upper protective layer 124 directly above the electrothermal conversion unit is used as an anode electrode, and a part electrically connectable to the upper protective layer 124 via ink is used as a cathode electrode, to cause an electrochemical reaction. In this case, the metal forming the upper protective layer 124 dissolves into the ink at the anode, and thus, kogation accumulated on the surface of the upper protective layer 124 is removed together with the metal. Removal of kogation restores the ink ejection speed that has decreased due to accumulation of the kogation.

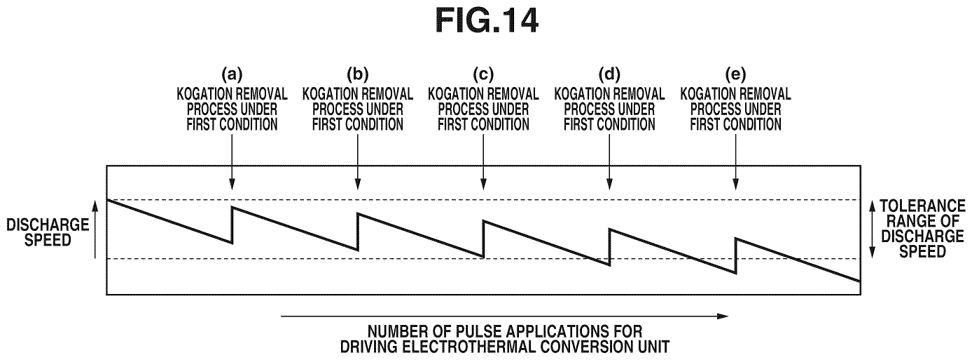

However, in a conventional kogation removal process, as heat generation by the electrothermal conversion unit is repeated, the kogation cannot be completely removed in one kogation removal process, which may gradually increase the amount of kogation accumulated. FIG. 14 illustrates change in the ink ejection speed based on the number of times the electrothermal conversion unit is driven, i.e., the number of pulse applications to drive the electrothermal conversion unit, in a case where the kogation removal process is performed under a predetermined condition. Hereinafter, the number of pulse applications will be referred to the number of times the electrothermal conversion unit is driven. When kogation removal is performed under a first condition in a process (a), and then, is performed under the first condition in a process (b), the ejection speed is not restored to the ejection speed restored immediately after the kogation removal performed in the process (a). In this case, as the number of pulse applications increases, the ejection speed gradually decreases. When kogation removal is performed under the first condition in a process (c), the ejection speed reaches the lower limit of the tolerance range of the ejection speed. Then, immediately before the kogation removal in processes (d) and (e), the ejection speed falls below the lower limit of the tolerance range of the ejection speed, causing deterioration of recording quality due to the decrease in the ejection speed. Such a decrease in the ejection speed due to accumulation of kogation can occur since the condition for the kogation removal process is constantly the first condition.

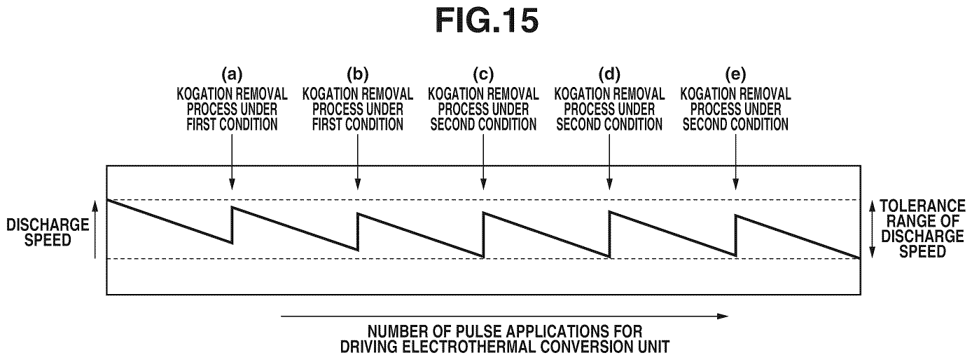

A kogation removal process in the embodiment will now be described with reference to FIG. 15. The kogation removal in the processes (a) and (b) in the embodiment is the same as the conventional kogation removal. However, in the process (c) when the ejection speed reaches the lower limit of the tolerance range, the kogation removal process is performed under a second condition that facilitates removal of kogation compared with the first condition. This reduces the risk that the ejection speed falls below the lower limit of the tolerance range even immediately before the processes (d) and (e), preventing deterioration of the recording quality. In the embodiment, the kogation removal process under the second condition is performed when the ejection speed reaches the lower limit of the tolerance range. However, the disclosure is not limited to this, and it is sufficient to perform the kogation removal process under the second condition after the kogation removal process under the first condition.

The second condition that facilitates removal of kogation compared with the first condition will be described. The second condition is not particularly limited as long as the condition allows easier removal of kogation than the first condition. Examples of the second condition include the duration of voltage application in the kogation removal process, the magnitude of the voltage applied, and the number of pulse applications between iterations of the kogation removal process. Specific examples of the second condition will be described.

After performing a kogation removal process under the first condition including applying a voltage over a first time, a kogation removal process can be performed under the second condition including applying a voltage over a second time longer than the first time. In this manner, kogation can be removed more easily under the second condition than the first condition, preventing a decrease in the ejection speed. The first and the second times each can be between 30 seconds and 150 seconds in order to prevent excessive dissolution of the upper protective layer 124 while kogation is being removed. In the first and the second times, a method can be employed of intermittently repeating short-duration voltage application for the first and the second times, or a method of continuously applying a voltage for the first and the second times. For an ink that is less prone to a decrease in the ejection speed, extending the duration of voltage application facilitates uniform removal of kogation accumulated on the upper protective layer 124. On the other hand, for an ink that is more prone to a decrease in the ejection speed, in one embodiment, the duration of voltage application is to be shortened.

The kogation removal process can also be performed under the first condition including applying a first voltage, and then performed under the second condition including applying a second voltage greater than the first voltage. As the magnitude of the voltage applied increases, the amount of the upper protective layer 124 dissolved by electrochemical reaction increases. Thus, the second condition facilitates removal of kogation compared with the first condition, preventing a decrease in the ejection speed. If the applied voltage is too large, the upper protective layer 124 excessively dissolves; thus, in one embodiment, the voltage in consideration of the balance is set between the removal of kogation and the deterioration of the function of the upper protective layer 124. Specifically, the first voltage and the second voltage can be each between 3 V and 5 V. Depending on the type of ink, increasing the applied voltage may generate positive ions, which can aggregate and potentially cause adhesion. Thus, the applied voltage can be increased for an ink type that is less prone to adhesion caused by increased voltage, and the first and the second times can be adjusted for an ink type that is prone to adhesion.

A method can also be employed in which the kogation removal process is performed under the first condition where the kogation removal process is performed each after pulses for driving the electrothermal conversion unit are applied a first number of times, and then the kogation removal process is performed under the second condition where the kogation removal process is performed each after pulses are applied a second number of times less than the first number of times. In this manner, after kogation has accumulated, the interval until the kogation removal process is performed (i.e., the number of pulse applications) is reduced, allowing the kogation removal process to be performed frequently, keeping the ejection speed within a tolerance range. As described above, the upper protective layer 124 is dissolved when the kogation removal process is performed, which may reduce the functionality of the upper protective layer 124. Thus, the first number of times and the second number of times can be set in consideration of the balance between the number of pulses applications before the kogation removal process is performed and the deterioration of the functionality of the upper protective layer 124. Specifically, the first number of times and the second number of times can be each between 2.5×10⁸ times and 6×10⁹ times.

In the above description, as a condition for the kogation removal process, the voltage application time, the magnitude of the voltage applied, or the number of pulse applications before a next kogation removal process is performed is changed. However, the kogation removal process can be performed by changing two of these conditions. Further, three or more conditions can be changed. By changing a plurality of conditions in the first condition and setting the second condition, kogation removal can be accurately performed in a manner suitable for the state of kogation accumulation.

Timings for performing the kogation removal process will be described. As described above, when the kogation removal process is performed, the upper protective layer 124 is dissolved to remove kogation. Consequently, if the kogation removal process is performed excessively, the functionality of the upper protective layer 124 can be reduced. Thus, the kogation removal process can be performed at timing when the ejection characteristics, such as the ejection speed, change. For example, when the ink ejection speed slows down by 2 m/s, image deteriorations, such as uneven density and misaligned lines, are likely to occur. Thus, in one embodiment, the kogation removal process is performed each time the ink ejection speed slows down by 2 m/s from the normal state. However, it is difficult to accurately measure the ink ejection speed to perform the kogation removal process accordingly. In one embodiment, the kogation removal process is performed depending on the number of pulses applied to drive the electrothermal conversion unit, from the consideration that the decrease in the ejection speed due to kogation accumulation is based on the number of pulses applied to drive the electrothermal conversion unit. Specifically, when the number of pulse applications to drive the electrothermal conversion unit exceeds a threshold value, in one embodiment, the kogation removal process is performed by switching from the first condition to the second condition.

After switching the condition for the kogation removal process from the first condition to the second condition, the condition can be returned to the first condition. This makes it possible to perform the kogation removal process under the second condition, which facilitates kogation removal only when necessary. In the above description, the first and second conditions are provided as conditions. However, the kogation removal process can be performed under three or more conditions, and is not limited to the two conditions. Even in this case, by performing the kogation removal process later under a condition that facilitates removal, kogation can be sufficiently removed regardless of the state of kogation accumulation.

(Control of Communication between Ink Ejection Head and Ink Ejection Apparatus Main Body)

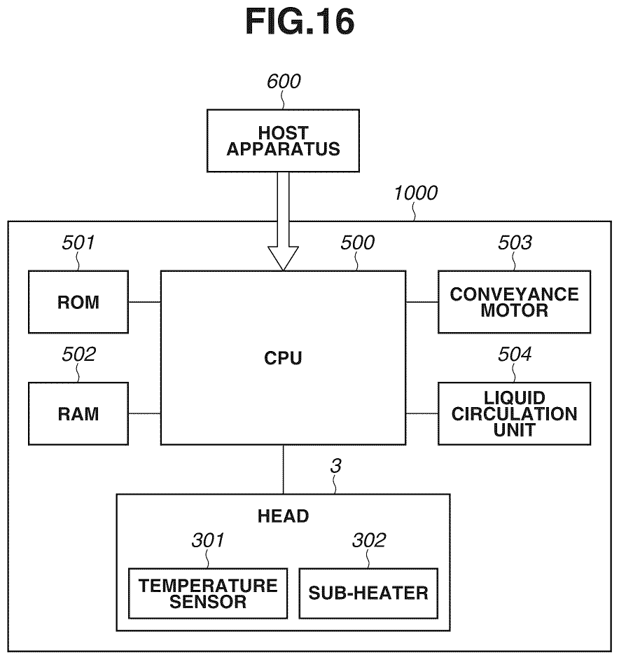

Hereinafter, control of communication between the ink ejection head and the ink ejection apparatus main body according to the embodiment will be described with reference to FIG. 16. FIG. 16 is a diagram modeling communication between the ink ejection head and the recording apparatus main body, and between the ink cartridge and the recording apparatus main body.

A main circuit board incorporated in the main body of the ink ejection apparatus 1000 includes a central processing unit (CPU) 500, a read-only memory (ROM) 501, a random-access memory (RAM) 502. The main circuit board receives from the head 3 temperature information about each recording element substrate 10 to transmit a control signal for driving each electrothermal conversion unit based on the received temperature information to the electric wiring board 90 of the ink ejection head 3. The ink ejection head 3 includes a temperature sensor 301, and a sub-heater 302 for preheating ink before heating the ink by energy that generates pressure for ejecting the ink from the ink ejection head 3.

In order to perform the kogation removal process according to the embodiment, the ink ejection apparatus can include a counting unit that counts the number of pulses applied to drive the electrothermal conversion unit, and a determination unit that determines whether the number of pulses applied exceeds a threshold value. The counting unit and the determination unit can have any of the configurations of the main circuit board described above, and the counting unit and the discrimination unit can have the same configuration.

### (Kogation Removal Process)

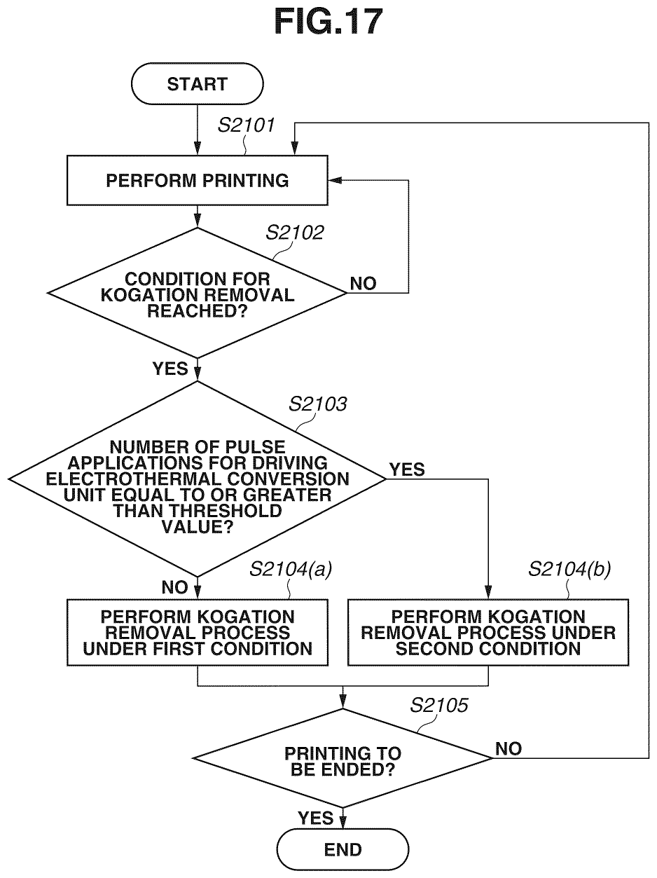

An image recording procedure including the kogation removal process according to the embodiment will now be described. FIG. 17 is a flowchart illustrating image recording. In step S2101, ink is ejected from the ink ejection head 3 to perform printing on a recording medium. At this time, the counting unit counts the number of pulses applied to the electrothermal conversion unit to eject the ink. In step S2102, it is determined whether the condition for performing the kogation removal process is met. If the result of the determination is false (NO in step S2102), the process returns to step S2101, and the processing is repeated until the result becomes true (YES in step S2102). If the result of the determination in step S2102 is true (YES in step S2102), in step S2103, the determination unit determines whether the number of pulses applied to drive the electrothermal conversion unit exceeds a threshold value. At this time, the counting unit has counted the number of pulses applied. If the result of the determination in step S2103 is false (NO in step S2103), the process proceeds to step S2104(a). In step S2104(a), the kogation removal process is performed under the first condition. On the other hand, if the result of the determination in step S2103 is true (YES in step S2103), the process proceeds to step S2104(b). In step S2104(b), the kogation removal process is performed under the second condition that facilitates kogation removal compared with the first condition. After steps S2104(a) and S2104(b), in step S2105, it is determined whether to end printing. If the result of the determination in step S2105 is false (NO in step S2105), the process returns to step S2101 again. On the other hand, if the result of the determination in step S2105 is true (YES is in step S2105), the image recording ends.

### Other Embodiments

As a cleaning configuration that removes kogation, a portion of the upper protective layer 124 directly above the heating resistor 126 can be used as one electrode, and as the other electrode, a ground can be used or a counter electrode 129 can be provided (FIG. 13).

In the first embodiment, an element that generates energy for ejecting ink is used as the electrothermal conversion unit. However, the electrothermal conversion unit can be an element that generates pressure for circulating ink in an ink flow path. Even if the electrothermal conversion unit is an element that generates pressure for circulating ink in an ink flow path, the upper protective layer 124 is provided directly above the element, and kogation accumulates on the upper protective layer 124. This may make it difficult for heat from the electrothermal conversion to act on the ink. For this reason, the cleaning method of the disclosure can be used.

Another example of the electrothermal conversion unit can be the sub-heater 302 (FIG. 16) provided on the ink ejection head 3. Kogation accumulated on the upper protective layer for the sub-heater 302 can also be removed by the cleaning method of the disclosure.

As described above, according to the disclosure, kogation can be sufficiently removed regardless of the state of kogation accumulation.

According to the disclosure, a cleaning method can be provided for sufficiently removing kogation regardless of the state of kogation accumulation, and an ink ejection apparatus capable of carrying out the cleaning method.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-185026, filed Oct. 21, 2024, which is hereby incorporated by reference herein in its entirety.

What is claimed is:

1. A method for removing kogation accumulated on an upper protective layer of an inkjet head including an electrothermal conversion unit disposed in an ink flow path communicating with an ejection port for ejecting ink, an insulating protective layer for blocking contact between the electrothermal conversion unit and the ink in the ink flow path, and the upper protective layer that covers a portion of the insulating protective layer to be heated by the electrothermal conversion unit, the method comprising:
removing kogation accumulated on a surface of the upper protective layer by applying a voltage in a state where the upper protective layer is used as an anode electrode and a portion connectable to the upper protective layer via the ink is used as a cathode electrode,
wherein removing kogation is performed under a first condition including applying the voltage over a first time, and then is performed under a second condition including applying the voltage over a second time longer than the first time.

2. A method for removing kogation accumulated on an upper protective layer of an inkjet head including an electrothermal conversion unit disposed in an ink flow path communicating with an ejection port for ejecting ink, an insulating protective layer for blocking contact between the electrothermal conversion unit and the ink in the ink flow path, and the upper protective layer configured to cover a portion of the insulating protective layer to be heated by the electrothermal conversion unit, the method comprising:
removing kogation through dissolution of a surface of the upper protective layer by applying a voltage in a state where the upper protective layer is used as an anode electrode and a portion connectable to the upper protective layer via the ink is used as a cathode electrode,
wherein removing kogation is performed under a first condition including applying a first voltage, and then is performed under a second condition including applying a second voltage greater in absolute value than the first voltage.

3. The method according to claim 1, wherein a condition for the removing kogation is switched from the first condition to the second condition in a case where the number of pulse applications for driving the electrothermal conversion unit is equal to or greater than a threshold value.

4. The method according to claim 1,
wherein the first condition includes applying a first voltage, and
wherein the second condition includes applying a second voltage greater than the first voltage.

5. The method according to claim 1,
wherein the first condition is that removing kogation is performed each time a pulse for driving the electrothermal conversion unit is applied a first number of times, and
wherein the second condition is that removing kogation is performed each time the pulse is applied a second number of times less than the first number of times.

6. The method according to claim 1,
wherein the first condition is that removing kogation is performed by applying a first voltage each time a pulse for driving the electrothermal conversion unit is applied a first number of times, and
wherein the second condition is that removing kogation is performed by applying a second voltage greater than the first voltage each time the pulse is applied a second number of times less than the first number of times.

7. The method according to claim 1, wherein the upper protective layer is formed of a material that does not form an oxide film that prevents dissolution of the upper protective layer, through heating by using the electrothermal conversion unit.

8. The method according to claim 1, wherein the upper protective layer is formed of a material containing iridium (Ir) or ruthenium (Ru).

9. The method according to claim 1, wherein the first time and the second time are each 30 seconds or more and 150 seconds or less.

10. The method according to claim 2, wherein the first voltage and the second voltage are each 3 V or more and 5 V or less.

11. The method according to claim 1, wherein the electrothermal conversion unit is an element that generates energy for ejecting the ink from the ejection port.

12. The method according to claim 1, wherein the electrothermal conversion unit is an element that generates pressure for circulating the ink in the ink flow path.

13. An apparatus comprising:
an inkjet head including an ejection port for ejecting ink, an electrothermal conversion unit disposed in an ink flow path communicating with the ejection port, an insulating protective layer for blocking contact between the electrothermal conversion unit and the ink in the ink flow path, and an upper protective layer that covers a portion of the insulating protective layer to be heated by the electrothermal conversion unit;
a counting unit configured to count the number of pulse applications for driving the electrothermal conversion unit; and
a determination unit configured to determine whether the number of the pulse applications is equal to or greater than a threshold value,
wherein, in a state where the upper protective layer is used as an anode electrode and a portion that is conductive to the upper protective layer via the ink is used as a cathode electrode, a surface of the upper protective layer is configured to be dissolved by electrochemical reaction, and
wherein the apparatus further comprises a change unit configured to switch a voltage to be applied for the electrochemical reaction from a first voltage to a second voltage greater than the first voltage in a case where a determination result by the determination unit is equal to or greater than a threshold value.
